(19) United States
(12) Patent Application Publication
(10) Pub. No.: US 2013/0298158 A1
(43) Pub. Date: Nov. 7, 2013

(54) ADVERTISEMENT PRESENTATION BASED ON A CURRENT MEDIA REACTION

(71) Applicants: Michael J. Conrad, Monroe, WA (US); Geoffrey J Hulten, Lynnwood, WA (US); Kyle J. Krum, Sammamish, WA (US); Umaimah A. Mendhro, San Francisco, CA (US); Darren B. Remington, Sammamish, WA (US); Enrique de la Garza, Sammamish, WA (US)

(72) Inventors: Michael J. Conrad, Monroe, WA (US); Geoffrey J Hulten, Lynnwood, WA (US); Kyle J. Krum, Sammamish, WA (US); Umaimah A. Mendhro, San Francisco, CA (US); Darren B. Remington, Sammamish, WA (US); Enrique de la Garza, Sammamish, WA (US)

(73) Assignee: MICROSOFT CORPORATION, Redmond, WA (US)

(21) Appl. No.: 13/488,046

(22) Filed: Jun. 4, 2012

(30) Foreign Application Priority Data
May 4, 2012 (CA) 2775814

(51) Int. Cl. H04N 21/458

(52) U.S. Cl. 725/34

(57) ABSTRACT

This document describes techniques and apparatuses enabling advertisement presentation based on a current media reaction. The techniques and apparatuses can receive a current media reaction of a user watching a media program and, based on this current media reaction, determine which advertisement is likely to be effective. Further, the techniques and apparatuses may inform advertisers of a current media reaction thereby enabling the advertisers to bid on a right to present an advertisement based on that reaction. By so doing, costs for advertisements may more-accurately reflect the value of the time in which they are presented and advertisements may be more effective.

### PRIORITY CLAIM

This application claims priority under 35 U.S.C. §119 to Canadian Patent Application Serial No. 2,775,814 filed in Canada on May 4, 2012 and titled “ADVERTISEMENT PRESENTATION BASED ON A CURRENT MEDIA REACTION,” the disclosure of which is incorporated by reference in its entirety herein.

### BACKGROUND

Currently, advertisers and media providers agree to advertising costs, such as a cost to present a commercial during a television show, based on a number and demographic of people expected to watch the program. Thus, a larger audience or a certain demographic group, such as men aged 18-34, may command a higher price than a smaller audience or other demographic group.

Also based on the number and demographic of the expected audience, some advertisers determine in advance what advertisements they want the media provider to present during the media program. Thus, an advertiser for a clothing store may select to present a commercial for a sale on men's clothes to an audience expected to include many men aged 18-34 or young women's clothes to an audience expected to include many young women aged 12-17.

### SUMMARY

This document describes techniques and apparatuses enabling advertisement presentation based on a current media reaction. The techniques and apparatuses can receive a current media reaction of a user watching a media program and, based on this current media reaction, determine which advertisement is likely to be effective. Further, the techniques and apparatuses may inform advertisers of a current media reaction thereby enabling the advertisers to bid on a right to present an advertisement based on that reaction. By so doing, costs for advertisements may more-accurately reflect the value of the time in which they are presented and advertisements may be more effective.

This summary is provided to introduce simplified concepts enabling advertisement presentation based on a current media reaction, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses enabling advertisement presentation based on a current media reaction are described with reference to the following drawings. The same numbers are used throughout the drawings to reference like features and components:

FIG. 1 illustrates an example environment in which techniques enabling advertisement presentation based on a current media reaction can be implemented, as well as other techniques.

FIG. 2 is an illustration of an example computing device that is local to the audience of FIG. 1.

FIG. 3 is an illustration of an example remote computing device that is remote to the audience of FIG. 1.

FIG. 4 illustrates example methods for determining media reactions based on passive sensor data.

FIG. 5 illustrates a time-based graph of media reactions, the media reactions being interest levels for one user and for forty time periods during presentation of a media program.

FIG. 6 illustrates example methods for building a reaction history.

FIG. 7 illustrates example methods for presenting an advertisement based on a current media reaction, including by determining which advertisement of multiple potential advertisements to present.

FIG. 8 illustrates current media reactions to a media program over a portion of the program as the program is being presented.

FIG. 9 illustrates example methods for presenting an advertisement based on a current media reaction, including based on bids from advertisers.

FIG. 10 illustrates the advertisement module of FIGS. 2 and 3 passing information through the communications network of FIG. 3 to multiple advertisers.

FIG. 11 illustrates methods for presenting an advertisement based on a current media reaction, including immediately following a scene in which the current media reaction was made.

FIG. 12 illustrates an example device in which techniques enabling advertisement presentation based on a current media reaction, as well as other techniques, can be implemented.

### DETAILED DESCRIPTION

Overview

This document describes techniques and apparatuses enabling advertisement presentation based on a current media reaction. These techniques and apparatuses enable media providers and advertisers to better price advertisements and determine which advertisement to present.

Consider, for example, a case where a beer company wishes to advertise its beer during a playoff football game. Assume that the beer company believes that an advertisement for its beer is more effective if it is tailored to a team of which a user watching the game is a fan. Based on this, assume that the beer company provides two advertisements to the media provider, one in which Team Red is shown prominently and favorably, and another advertisement in which the other team, Team Black, is shown prominently and favorably. Assume that a user is watching the game and cheers when Team Red scores a touchdown. Assume also that because of the change in possession caused by the touchdown, the media provider will be playing advertisements in about 30 seconds—right after the replay of the touchdown. The techniques receive the current media reaction of the user, here the user's cheer at the Team Red touchdown. The techniques then determine which advertisement to present from the set of two advertisements, here the Team Red beer advertisement, based on the current media reaction (the cheer) indicating that the user is a fan of Team Red. By so doing, an advertisement is targeted to a user based on the user's current media reaction.

This is but one example of how techniques and/or apparatuses enabling advertisement presentation based on a current media reaction can be performed. Techniques and/or apparatuses are referred to herein separately or in conjunction as the “techniques” as permitted by the context. This document now turns to an example environment in which the techniques can be embodied and then various example methods that can, but are not required to, work in conjunction with the techniques. Some of these various methods include methods for sensing reactions to media and building a reaction history for a user. After these various example methods, this document turns to example methods for advertisement presentation based on a current media reaction.

Example Environment

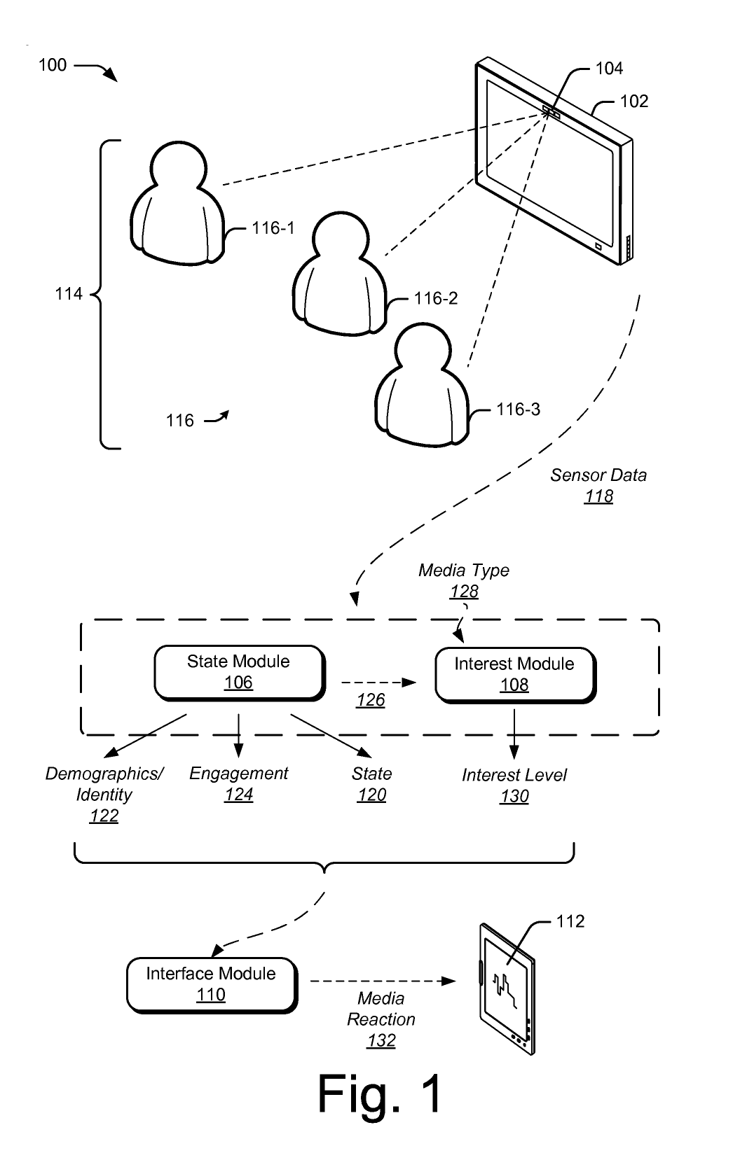

FIG. 1 is an illustration of an example environment 100 for receiving sensor data and determining media reactions based on this sensor data. These determined media reactions can be used to build a user's reaction history, which can also be useful in combination with a user's current media reaction in determining a price or advertisement to present. This reaction history can be based in part on: contexts in which the user's reactions are sensed; other persons' reaction histories having similarities to the user's reactions or demographics; passively-sensed, actively recorded, or explicitly prompted user reactions; and/or reactions to portions of a media program, such as a one-second period of an advertisement or a particular scene of a television program.

Environment 100 includes a media presentation device 102, an audience-sensing device 104, a state module 106, an interest module 108, an interface module 110, and a user interface 112.

Media presentation device 102 presents a media program to an audience 114 having one or more users 116. A media program can include, alone or in combination, a television show, a movie, a music video, a video clip, an advertisement, a blog, a photograph, a web page, an e-book, a computer game, a song, a tweet, or other audio and/or video media. Audience 114 can include one or more users 116 that are in locations enabling consumption of a media program presented by media presentation device 102 and measurement by audience-sensing device 104, whether separately or within one audience 114. In audience 114 three users are shown: user 116-1, user 116-2, and user 116-3.

Audience-sensing device 104 is capable of sensing audience 114 and providing sensor data for audience 114 to state module 106 and/or interest module 108 (sensor data 118 shown provided via an arrow). The data sensed can be sensed passively, actively, and/or responsive to an explicit prompt.

Passively sensed data is passive by not requiring active participation of users in the measurement of those users. Actively sensed data includes data recorded by users in an audience, such as with handwritten logs, and data sensed from users through biometric sensors worn by users in the audience. Sensor data sensed responsive to an explicit prompt can be sensed actively or passively. One example is an advertisement that requests, during the advertisement, that a user raises his or her hand if he or she would like a coupon for a free sample of a product to be sent to the user by mail. In such a case, the user is expressing a reaction of raising a hand, though this can be passively sensed by not requiring the user to actively participate in the measurement of the reaction. The techniques sense this raised hand in various manners as set forth below.

Sensor data can include data sensed using emitted light or other signals sent by audience-sensing device 104, such as with an infrared sensor bouncing emitted infrared light off of users or the audience space (e.g., a couch, walls, etc.) and sensing the light that returns. Examples of sensor data measuring a user and ways in which it can be measured are provided in greater detail below.

Audience-sensing device 104 may or may not process sensor data prior to providing it to state module 106 and/or interest module 108. Thus, sensor data may be or include raw data or processed data, such as: RGB (Red, Green, Blue) frames; infrared data frames; depth data; heart rate; respiration rate; a user's head orientation or movement (e.g., coordinates in three dimensions, x, y, z, and three angles, pitch, tilt, and yaw); facial (e.g., eyes, nose, and mouth) orientation, movement, or occlusion; skeleton's orientation, movement, or occlusion; audio, which may include information indicating orientation sufficient to determine from which user the audio originated or directly indicating which user, or what words were said, if any; thermal readings sufficient to determine or indicating presence and locations of one of users 116; and distance from the audience-sensing device 104 or media presentation device 102. In some cases audience-sensing device 104 includes infrared sensors (webcams, Kinect cameras), stereo microphones or directed audio microphones, and a thermal reader (in addition to infrared sensors), though other sensing apparatuses may also or instead be used.

State module 106 receives sensor data and determines, based on the sensor data, states 120 of users 116 in audience 114 (shown at arrow). States include, for example: sad, talking, disgusted, afraid, smiling, scowling, placid, surprised, angry, laughing, screaming, clapping, waving, cheering, looking away, looking toward, leaning away, leaning toward, asleep, or departed, to name just a few.

The talking state can be a general state indicating that a user is talking, though it may also include subcategories based on the content of the speech, such as talking about the media program (related talking) or talking that is unrelated to the media program (unrelated talking). State module 106 can determine which talking category through speech recognition.

State module 106 may also or instead determine, based on sensor data, a number of users, a user's identity and/or demographic data (shown at 122), or engagement (shown at 124) during presentation. Identity indicates a unique identity for one of users 116 in audience 114, such as Susan Brown. Demographic data classifies one of users 116, such as 5 feet, 4 inches tall, young child, and male or female. Engagement indicates whether a user is likely to be paying attention to the media program, such as based on that user's presence or head orientation. Engagement, in some cases, can be determined by state module 106 with lower-resolution or less-processed sensor data compared to that used to determine states. Even so, engagement can be useful in measuring an audience, whether on its own or to determine a user's interest using interest module 108.

Interest module 108 determines, based on sensor data 118 and/or a user's engagement or state (shown with engagement/state 126 at arrow) and information about the media program (shown at media type 128 at arrow), that user's interest level 130 (shown at arrow) in the media program. Interest module 108 may determine, for example, that multiple laughing states for a media program intended to be a serious drama indicate a low level of interest and conversely, that for a media program intended to be a comedy, that multiple laughing states indicate a high level of interest.

As illustrated in FIG. 1, state module 106 and/or interest module 108 provide demographics/identity 122 as well as one or more of the following media reactions: engagement 124, state 120, or interest level 130, all shown at arrows in FIG. 1. Based on one or more of these media reactions, state module 106 and/or interest module 108 may also provide another type of media reaction, that of overall media reactions to a media program, such as a rating (e.g., thumbs up or three stars). In some cases, however, media reactions are received and overall media reactions are determined instead by interface module 110.

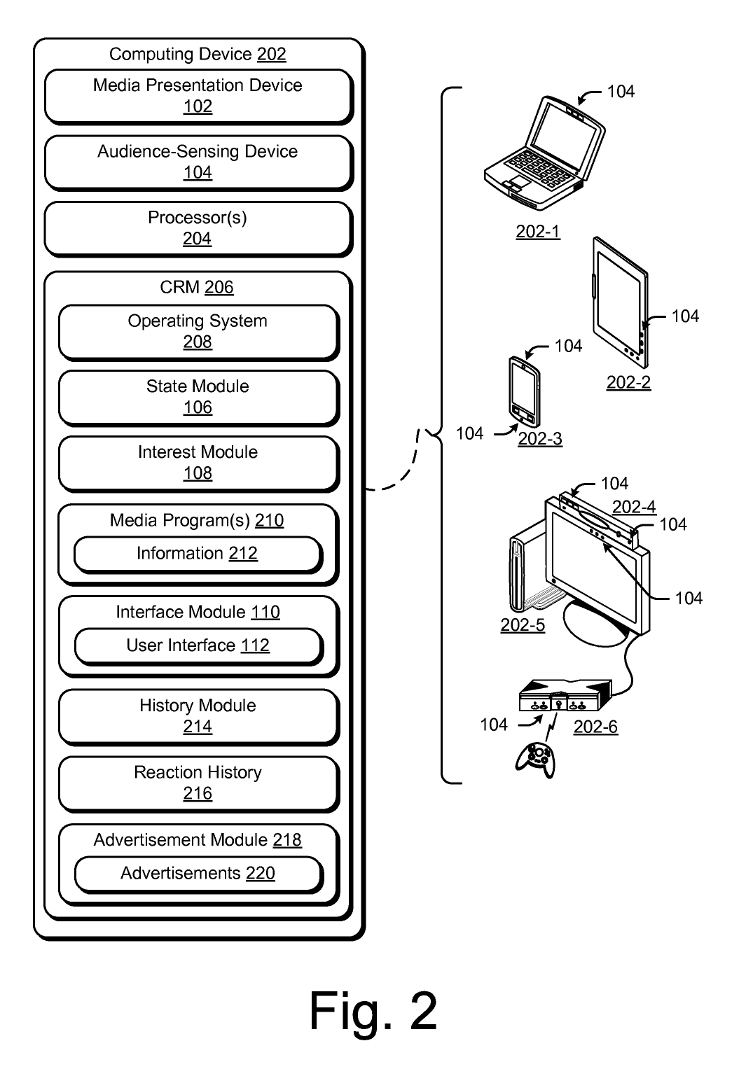

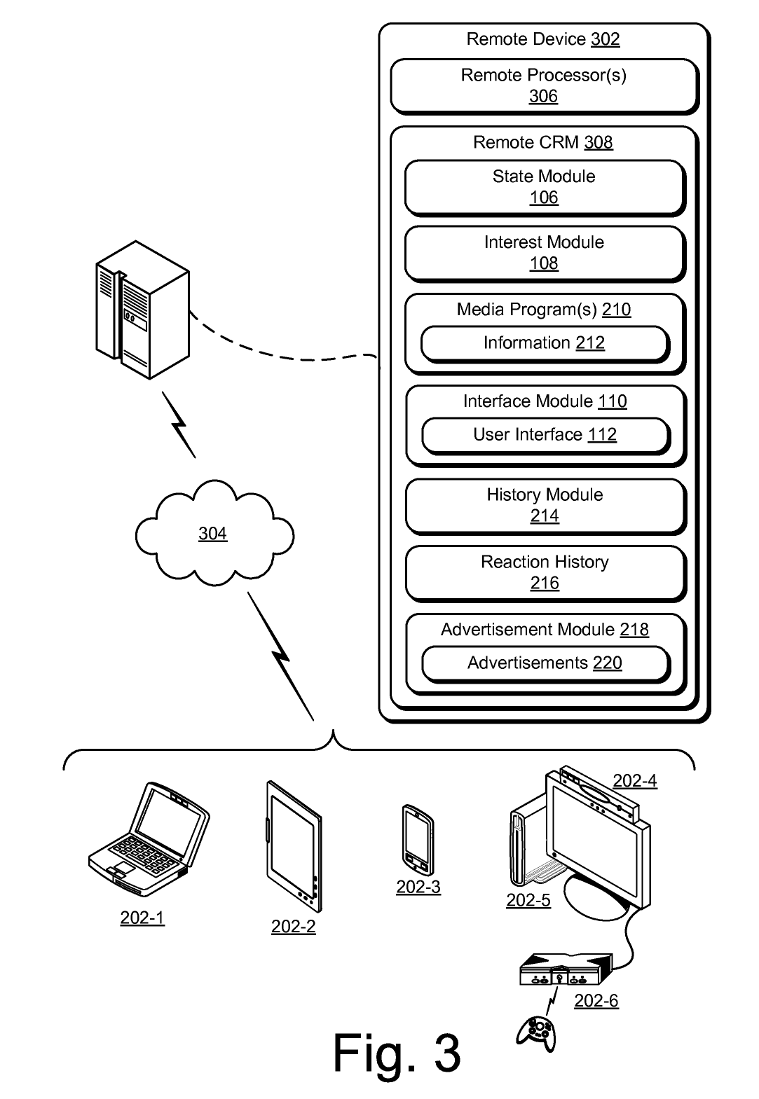

State module 106 and interest module 108 can be local to audience 114, and thus media presentation device 102 and audience-sensing device 104, though this is not required. An example embodiment where state module 106 and interest module 108 are local to audience 114 is shown in FIG. 2. In some cases, however, state module 106 and/or interest module 108 are remote from audience 114, which is illustrated in FIG. 3.

Interface module 110 receives media reactions and demographics/identity information, and determines or receives some indication as to which media program or portion thereof that the reactions pertain. Interface module 110 presents, or causes to be presented, a media reaction 132 to a media program through user interface 112, though this is not required. This media reaction can be any of the above-mentioned reactions, some of which are presented in a time-based graph, through an avatar showing the reaction, or a video or audio of the user recorded during the reaction, one or more of which is effective to how a user's reaction over the course of the associated media program.

Interface module 110 can be local to audience 114, such as in cases where one user is viewing his or her own media reactions or those of a family member. In many cases, however, interface module 110 receives media reactions from a remote source.

Note that sensor data 118 may include a context in which a user is reacting to media or a current context for a user for which ratings or recommendations for media are requested. Thus, audience-sensing device 104 may sense that a second person is in the room or is otherwise in physical proximity to the first person, which can be context for the first person. Contexts may also be determined in other manners described in FIG. 2 below.

FIG. 2 is an illustration of an example computing device 202 that is local to audience 114. Computing device 202 includes or has access to media presentation device 102, audience-sensing device 104, one or more processors 204, and computer-readable storage media (“CRM”) 206.

CRM 206 includes an operating system 208, state module 106, interest module 108, media program(s) 210, each of which may include or have associated program information 212, interface module 110, user interface 112, history module 214, reaction history 216, and advertisement module 218, which may include multiple advertisements 220.

History module 214 includes or has access to reaction history 216. History module 214 may build and update reaction history 216 based on ongoing reactions by the user (or others as noted below) to media programs. In some cases history module 214 determines various contexts for a user, though this may instead be determined and received from other entities. Thus, in some cases history module 214 determines a time, a locale, weather at the locale, and so forth, during the user's reaction to a media program or request for ratings or recommendations for a media program. Further, history module 214 may determine ratings and/or recommendations for media based on a current context for a user and reaction history 216.

Advertisement module 218 receives a current media reaction of a user, such as one or more of engagements 124, states 120, and interest levels 130. With this current media reaction, advertisement module 218 may determine an advertisement of multiple advertisements 220 to present to the user. Advertisement module 218 may also or instead provide the current media reaction to advertisers, receive bids from advertisers for a right to present an advertisement, and then cause an advertisement to be presented to the user. This advertisement may be previously stored as one of advertisements 220 or received contemporaneously, such as by streaming the advertisement from a remote source responsive to the accompanying bid being a highest bid. Note that in either of these cases, advertisement module 218 may be local or remote from computing device 202 and thus the user (e.g., user 116-1 of audience 114 of FIG. 1).

Note that in this illustrated example, entities including media presentation device 102, audience-sensing device 104, state module 106, interest module 108, interface module 110, history module 214, and advertisement module 218 are included within a single computing device, such as a desktop computer having a display, forward-facing camera, microphones, audio output, and the like. Each of these entities, however, may be separate from or integral with each other in one or multiple computing devices or otherwise. As will be described in part below, media presentation device 102 can be integral with audience-sensing device 104 but be separate from state module 106, interest module 108, interface module 110, history module 214, or advertisement module 218. Further, each of these modules may operate on separate devices or be combined in one device.

As shown in FIG. 2, computing device(s) 202 can each be one or a combination of various devices, here illustrated with six examples: a laptop computer 202-1, a tablet computer 202-2, a smart phone 202-3, a set-top box 202-4, a desktop 202-5, and a gaming system 202-6, though other computing devices and systems, such as televisions with computing capabilities, netbooks, and cellular phones, may also be used. Note that three of these computing devices 202 include media presentation device 102 and audience-sensing device 104 (laptop computer 202-1, tablet computer 202-2, smart phone 202-3). One device excludes but is in communication with media presentation device 102 and audience-sensing device 104 (desktop 202-5). Two others exclude media presentation device 102 and may or may not include audience-sensing device 104, such as in cases where audience-sensing device 104 is included within media presentation device 102 (set-top box 202-4 and gaming system 202-6).

FIG. 3 is an illustration of an example remote computing device 302 that is remote to audience 114. FIG. 3 also illustrates a communications network 304 through which remote computing device 302 communicates with audience-sensing device 104 (not shown, but embodied within, or in communication with, computing device 202), interface module 110, history module 214 (including or excluding reaction history 216), and/or advertisement module 218 (including or excluding advertisements 220). Communication network 304 may be the Internet, a local-area network, a wide-area network, a wireless network, a USB hub, a computer bus, another mobile communications network, or a combination of these.

Remote computing device 302 includes one or more processors 306 and remote computer-readable storage media (“remote CRM”) 308. Remote CRM 308 includes state module 106, interest module 108, media program(s) 210, each of which may include or have associated program information 212, history module 214, reaction history 216, advertisement module 218, and advertisements 220.

Note that in this illustrated example, media presentation device 102 and audience-sensing device 104 are physically separate from state module 106 and interest module 108, with the first two local to an audience viewing a media program and the second two operating remotely. Thus, sensor data is passed from audience-sensing device 104 to one or both of state module 106 or interest module 108, which can be communicated locally (FIG. 2) or remotely (FIG. 3). Further, after determination by state module 106 and/or interest module 108, various media reactions and other information can be communicated to the same or other computing devices 202 for receipt by interface module 110, history module 214, and/or advertisement module 218. Thus, in some cases a first of computing devices 202 may measure sensor data, communicate that sensor data to remote device 302, after which remote device 302 communicates media reactions to another of computing devices 202, all through network 304.

These and other capabilities, as well as ways in which entities of FIGS. 1-3 act and interact, are set forth in greater detail below. These entities may be further divided, combined, and so on. The environment 100 of FIG. 1 and the detailed illustrations of FIGS. 2 and 3 illustrate some of many possible environments capable of employing the described techniques.

Example Methods

Determining Media Reactions Based on Passive Sensor Data

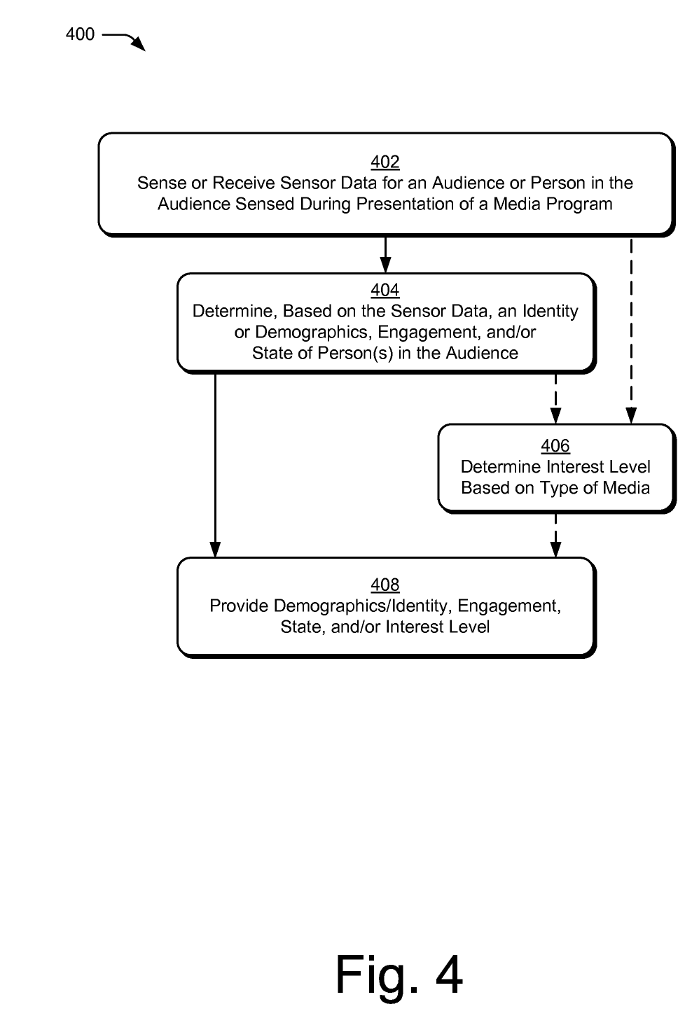

FIG. 4 depicts methods 400 determines media reactions based on passive sensor data. These and other methods described herein are shown as sets of blocks that specify operations performed but are not necessarily limited to the order shown for performing the operations by the respective blocks. In portions of the following discussion reference may be made to environment 100 of FIG. 1 and entities detailed in FIGS. 2-3, reference to which is made for example only. The techniques are not limited to performance by one entity or multiple entities operating on one device.

Block 402 senses or receives sensor data for an audience or user, the sensor data passively sensed during presentation of a media program to the audience or user. This sensor data may include a context of the audience or user or a context may be received separately.

Consider, for example, a case where an audience includes three users 116, users 116-1, 116-2, and 116-3 all of FIG. 1. Assume that media presentation device 102 is an LCD display having speakers and through which the media program is rendered and that the display is in communication with set-top box 202-4 of FIG. 2. Here audience-sensing device 104 is a Kinect, forward-facing high-resolution infrared red-green-blue sensor and two microphones capable of sensing sound and location that is integral with set-top box 202-4 or media presentation device 102. Assume also that the media program 210 being presented is a PG-rated animated movie named Incredible Family, which is streamed from a remote source and through set-top box 202-4. Set-top box 202-4 presents Incredible Family with six advertisements, spaced one at the beginning of the movie, three in a three-ad block, and two in a two-ad block.

Sensor data is received for all three users 116 in audience 114; for this example consider first user 116-1. Assume here that, over the course of Incredible Family, that audience-sensing device 104 measures, and then provides at block 402, the following at various times for user 116-1:
Time 1, head orientation 3 degrees, no or low-amplitude audio.
Time 2, head orientation 24 degrees, no audio.
Time 3, skeletal movement (arms), high-amplitude audio.
Time 4, skeletal movement (arms and body), high-amplitude audio.
Time 5, head movement, facial-feature change (20%), moderate-amplitude audio.
Time 6, detailed facial orientation data, no audio.
Time 7, skeletal orientation (missing), no audio.
Time 8, facial orientation, respiration rate.

Block 404 determines, based on the sensor data, a state of the user during the media program. In some cases block 404 determines a probability for the state or multiple probabilities for multiple states, respectively. For example, block 404 may determine a state likely to be correct but with less than full certainty (e.g., 40% chance that the user is laughing). Block 404 may also or instead determine that multiple states are possible based on the sensor data, such as a sad or placid state, and probabilities for each (e.g., sad state 65%, placid state 35%).

Block 404 may also or instead determine demographics, identity, and/or engagement. Further, methods 400 may skip block 404 and proceed directly to block 406, as described later below.

In the ongoing example, state module 106 receives the above-listed sensor data and determines the following corresponding states for user 116-1:
Time 1: Looking toward.
Time 2: Looking away.
Time 3: Clapping.
Time 4: Cheering.
Time 5: Laughing.
Time 6: Smiling.
Time 7: Departed.
Time 8: Asleep.

At Time 1 state module 106 determines, based on the sensor data indicating a 3-degree deviation of user 116-1's head from looking directly at the LCD display and a rule indicating that the looking toward state applies for deviations of less than 20 degrees (by way of example only), that user 116-1's state is looking toward the media program. Similarly, at Time 2, state module 106 determines user 116-1 to be looking away due to the deviation being greater than 20 degrees.

At Time 3, state module 106 determines, based on sensor data indicating that user 116-1 has skeletal movement in his arms and audio that is high amplitude that user 116-1 is clapping. State module 106 may differentiate between clapping and other states, such as cheering, based on the type of arm movement (not indicated above for brevity). Similarly, at Time 4, state module 106 determines that user 116-1 is cheering due to arm movement and high-amplitude audio attributable to user 116-1.

At Time 5, state module 106 determines, based on sensor data indicating that user 116-1 has head movement, facial-feature changes of 20%, and moderate-amplitude audio, that user 116-1 is laughing. Various sensor data can be used to differentiate different states, such as screaming, based on the audio being moderate-amplitude rather than high-amplitude and the facial-feature changes, such as an opening of the mouth and a rising of both eyebrows.

For Time 6, audience-sensing device 104 processes raw sensor data to provide processed sensor data, and in this case facial recognition processing to provide detailed facial orientation data. In conjunction with no audio, state module 106 determines that the detailed facial orientation data (here upturned lip corners, amount of eyelids covering eyes) that user 116-1 is smiling.

At Time 7, state module 106 determines, based on sensor data indicating that user 116-1 has skeletal movement moving away from the audience-sensing device 104, that user 116-1 is departed. The sensor data may indicate this directly as well, such as in cases where audience-sensing device 104 does not sense user 116-1's presence, either through no skeletal or head readings or a thermal signature no longer being received.

At Time 8, state module 106 determines, based on sensor data indicating that user 116-1's facial orientation has not changed over a certain period (e.g., the user's eyes have not blinked) and a steady, slow respiration rate that user 116-1 is asleep.

These eight sensor readings are simplified examples for purpose of explanation. Sensor data may include extensive data as noted elsewhere herein. Further, sensor data may be received measuring an audience every fraction of a second, thereby providing detailed data for tens, hundreds, and thousands of periods during presentation of a media program and from which states or other media reactions may be determined.

Returning to methods 400, block 404 may determine demographics, identity, and engagement in addition to a user's state. State module 106 may determine or receive sensor data from which to determine demographics and identity or receive, from audience-sensing device 104, the demographics or identity. Continuing the ongoing example, the sensor data for user 116-1 may indicate that user 116-1 is John Brown, that user 116-2 is Lydia Brown, and that user 116-3 is Susan Brown. Or sensor data may indicate that user 116-1 is six feet, four inches tall and male (based on skeletal orientation), for example. The sensor data may be received with or include information indicating portions of the sensor data attributable separately to each user in the audience. In this present example, however, assume that audience-sensing device 104 provides three sets of sensor data, with each set indicating the identity of the user along with the sensor data.

Also at block 404, the techniques may determine an engagement of an audience or user in the audience. As noted, this determination can be less refined than that of states of a user, but nonetheless is useful. Assume for the above example, that sensor data is received for user 116-2 (Lydia Brown), and that this sensor data includes only head and skeletal orientation:
Time 1, head orientation 0 degrees, skeletal orientation upper torso forward of lower torso.
Time 2, head orientation 2 degrees, skeletal orientation upper torso forward of lower torso.
Time 3, head orientation 5 degrees, skeletal orientation upper torso approximately even with lower torso.
Time 4, head orientation 2 degrees, skeletal orientation upper torso back from lower torso.
Time 5, head orientation 16 degrees, skeletal orientation upper torso back from lower torso.
Time 6, head orientation 37 degrees, skeletal orientation upper torso back from lower torso.
Time 7, head orientation 5 degrees, skeletal orientation upper torso forward of lower torso.
Time 8, head orientation 1 degree, skeletal orientation upper torso forward of lower torso.

State module 106 receives this sensor data and determines the following corresponding engagement for Lydia Brown:
Time 1: Engagement High.
Time 2: Engagement High.
Time 3: Engagement Medium-High.
Time 4: Engagement Medium.
Time 5: Engagement Medium-Low.
Time 6: Engagement Low.
Time 7: Engagement High.
Time 8: Engagement High.

At Times 1, 2, 7, and 8, state module 106 determines, based on the sensor data indicating a 5-degree-or-less deviation of user 116-2's head from looking directly at the LCD display and skeletal orientation of upper torso forward of lower torso (indicating that Lydia is leaning forward to the media presentation) that Lydia is highly engaged in Incredible Family at these times.

At Time 3, state module 106 determines that Lydia's engagement level has fallen due to Lydia no longer leaning forward. At Time 4, state module 106 determines that Lydia's engagement has fallen further to medium based on Lydia leaning back, even though she is still looking almost directly at Incredible Family.

At Times 5 and 6, state module 106 determines Lydia is less engaged, falling to Medium-Low and then Low engagement based on Lydia still leaning back and looking slightly away (16 degrees) and then significantly away (37 degrees), respectively. Note that at Time 7 Lydia quickly returns to a High engagement, which media creators are likely interested in, as it indicates content found to be exciting or otherwise captivating.

Methods 400 may proceed directly from block 402 to block 406, or from block 404 to block 406 or block 408. If proceeding to block 406 from block 404, the techniques determine an interest level based on the type of media being presented and the user's engagement or state. If proceeding to block 406 from block 402, the techniques determine an interest level based on the type of media being presented and the user's sensor data, without necessarily first or independently determining the user's engagement or state.

Continuing the above examples for users 116-1 and 116-2, assume that block 406 receives states determined by state module 106 at block 404 for user 116-1 (John Brown). Based on the states for John Brown and information about the media program, interest module 108 determines an interest level, either overall or over time, for Incredible Family. Assume here that Incredible Family is both an adventure and a comedy program, with portions of the movie marked as having one of these media types. While simplified, assume that Times 1 and 2 are marked as comedy, Times 3 and 4 are marked as adventure, Times 5 and 6 are marked as comedy, and that Times 7 and 8 are marked as adventure. Revisiting the states determined by state module 106, consider the following again:
Time 1: Looking toward.
Time 2: Looking away.
Time 3: Clapping.
Time 4: Cheering.
Time 5: Laughing.
Time 6: Smiling.
Time 7: Departed.
Time 8: Asleep.

Based on these states, state module 106 determines for Time 1 that John Brown has a medium-low interest in the content at Time 1—if this were of an adventure or drama type, state module 106 may determine John Brown to instead be highly interested. Here, however, due to the content being comedy and thus intended to elicit laughter or a similar state, interest module 108 determines that John Brown has a medium-low interest at Time 1. Similarly, for Time 2, interest module 108 determines that John Brown has a low interest at Time 2 because his state is not only not laughing or smiling but is looking away.

At Times 3 and 4, interest module 108 determines, based on the adventure type for these times and states of clapping and cheering, that John Brown has a high interest level. At time 6, based on the comedy type and John Brown smiling, that he has a medium interest at this time.

At Times 7 and 8, interest module 108 determines that John Brown has a very low interest. Here the media type is adventure, though in this case interest module 108 would determine John Brown's interest level to be very low for most types of content.

As can be readily seen, advertisers, media providers, and media creators can benefit from knowing a user's interest level. Here assume that the interest level is provided over time for Incredible Family, along with demographic information about John Brown. With this information from numerous demographically similar users, a media creator may learn that male adults are interested in some of the adventure content but that most of the comedy portions are not interesting, at least for this demographic group.

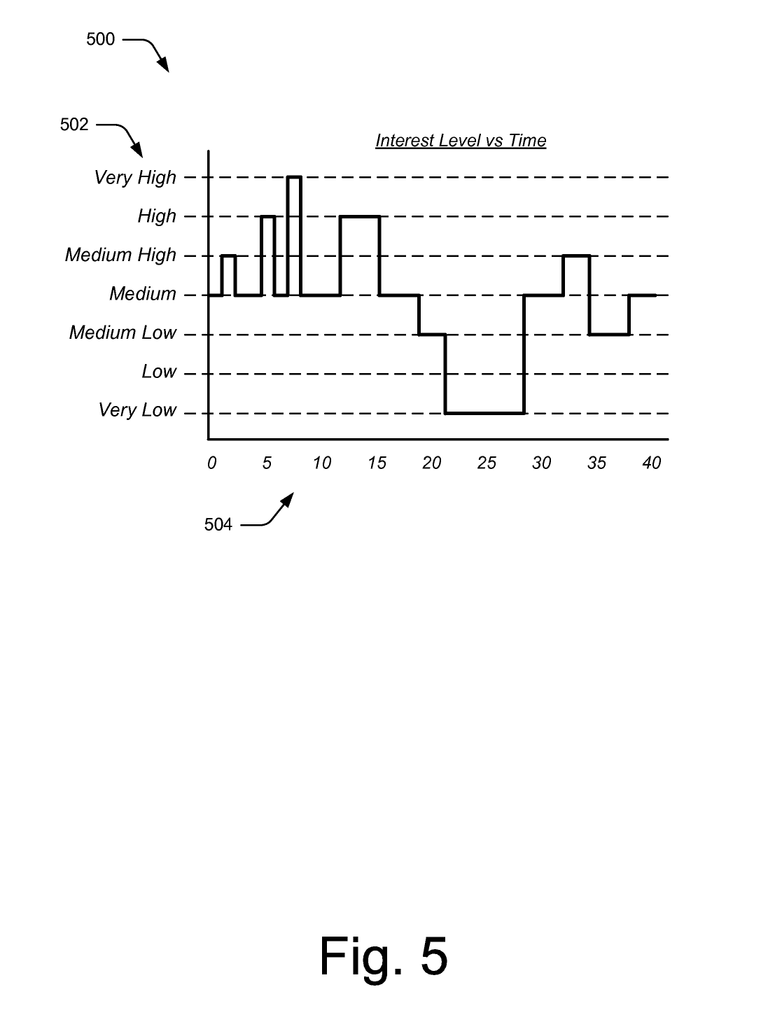

Consider, by way of a more-detailed example, FIG. 5, which illustrates a time-based graph 500 having interest levels 502 for forty time periods 504 over a portion of a media program. Here assume that the media program is a movie that includes other media programs—advertisements—at time periods 18 to 30. Interest module 108 determines, as shown, that the user begins with a medium interest level, and then bounces between medium and medium-high, high, and very high interest levels to time period 18. During the first advertisement, which covers time periods 18 to 22, interest module 108 determines that the user has a medium low interest level. For time periods 23 to 28, however, interest module 108 determines that the user has a very low interest level (because he is looking away and talking or left the room, for example). For the last advertisement, which covers time period 28 to 32, however, interest module 108 determines that the user has a medium interest level for time periods 29 to 32—most of the advertisement.

This can be valuable information—the user stayed for the first advertisement, left for the middle advertisement and the beginning of the last advertisement, and returned, with medium interest, for most of the last advertisement. Contrast this resolution and accuracy of interest with some conventional approaches, which likely would provide no information about how many of the people that watched the movie actually watched the advertisements, which ones, and with what amount of interest. If this example is a common trend with the viewing public, prices for advertisements in the middle of a block would go down, and other advertisement prices would be adjusted as well. Or, advertisers and media providers might learn to play shorter advertisement blocks having only two advertisements, for example. Interest levels 502 also provide valuable information about portions of the movie itself, such as through the very high interest level at time period 7 (e.g., a particularly captivating scene of a movie) and the waning interest at time periods 35-38.

Note that, in some cases, engagement levels, while useful, may be less useful or accurate than states and interest levels. For example, state module 106 may determine, for just engagement levels, that a user is not engaged if the user's face is occluded (blocked) and thus not looking at the media program. If the user's face is blocked by that user's hands (skeletal orientation) and audio indicates high-volume audio, state module 106, when determining states, may determine the user to be screaming. A screaming state indicates, in conjunction with the content being horror or suspense, an interest level that is very high. This is but one example of where an interest level can be markedly different from that of an engagement level.

As noted above, methods 400 may proceed directly from block 402 to block 406. In such a case, interest module 108, either alone or in conjunction with state module 106, determines an interest level based on the type of media (including multiple media types for different portions of a media program) and the sensor data. By way of example, interest module 108 may determine that for sensor data for John Brown at Time 4, which indicates skeletal movement (arms and body), and high-amplitude audio, and a comedy, athletics, conflict-based talk show, adventure-based video game, tweet, or horror types, that John Brown has a high interest level at Time 4. Conversely, interest module 108 may determine that for the same sensor data at Time 4 for a drama, melodrama, or classical music, that John Brown has a low interest level at Time 4. This can be performed based on the sensor data without first determining an engagement level or state, though this may also be performed.

Block 408, either after block 404 or 406, provides the demographics, identity, engagement, state, and/or interest level. State module 106 or interest module 108 may provide this information to various entities, such as interface module 110, history module 214, and/or advertisement module 218, as well as others.

Providing this information to an advertiser after presentation of an advertisement in which a media reaction is determined can be effective to enable the advertiser to measure a value of their advertisements shown during a media program. Providing this information to a media creator can be effective to enable the media creator to assess a potential value of a similar media program or portion thereof. For example, a media creator, prior to releasing the media program to the general public, may determine portions of the media program that are not well received, and thus alter the media program to improve it.

Providing this information to a rating entity can be effective to enable the rating entity to automatically rate the media program for the user. Still other entities, such as a media controller, may use the information to improve media control and presentation. A local controller may pause the media program responsive to all of the users in the audience departing the room, for example.

Providing media reactions to history module 214 can be effective to enable history module 214 to build and update reaction history 216. History module 214 may build reaction history 216 based on a context or contexts in which each set of media reactions to a media program are received, or the media reactions may, in whole or in part, factor in a context into the media reactions. Thus, a context for a media reaction where the user is watching a television show on a Wednesday night after work may be altered to reflect that the user may be tired from work.

As noted herein, the techniques can determine numerous states for a user over the course of most media programs, even for 15-second advertisements or video snippets. In such a case block 404 is repeated, such as at one-second periods.

Furthermore, state module 106 may determine not only multiple states for a user over time, but also various different states at a particular time. A user may be both laughing and looking away, for example, both of which are states that may be determined and provided or used to determine the user's interest level.

Further still, either or both of state module 106 and interest module 108 may determine engagement, states, and/or interest levels based on historical data in addition to sensor data or media type. In one case a user's historical sensor data is used to normalize the user's engagement, states, or interest levels (e.g., dynamically for a current media reaction). If, for example, Susan Brown is viewing a media program and sensor data for her is received, the techniques may normalize or otherwise learn how best to determine engagement, states, and interest levels for her based on her historical sensor data. If Susan Brown's historical sensor data indicates that she is not a particularly expressive or vocal user, the techniques may adjust for this history. Thus, lower-amplitude audio may be sufficient to determine that Susan Brown laughed compared to an amplitude of audio used to determine that a typical user laughed.

In another case, historical engagement, states, or interest levels of the user for which sensor data is received are compared with historical engagement, states, or interest levels for other people. Thus, a lower interest level may be determined for Lydia Brown based on data indicating that she exhibits a high interest for almost every media program she watches compared to other people's interest levels (either generally or for the same media program). In either of these cases the techniques learn over time, and thereby can normalize engagement, states, and/or interest levels.

Methods for Building a Reaction History

As noted above, the techniques may determine a user's engagement, state, and/or interest level for various media programs. Further, these techniques may do so using passive or active sensor data. With these media reactions, the techniques may build a reaction history for a user. This reaction history can be used in various manners as set forth elsewhere herein.

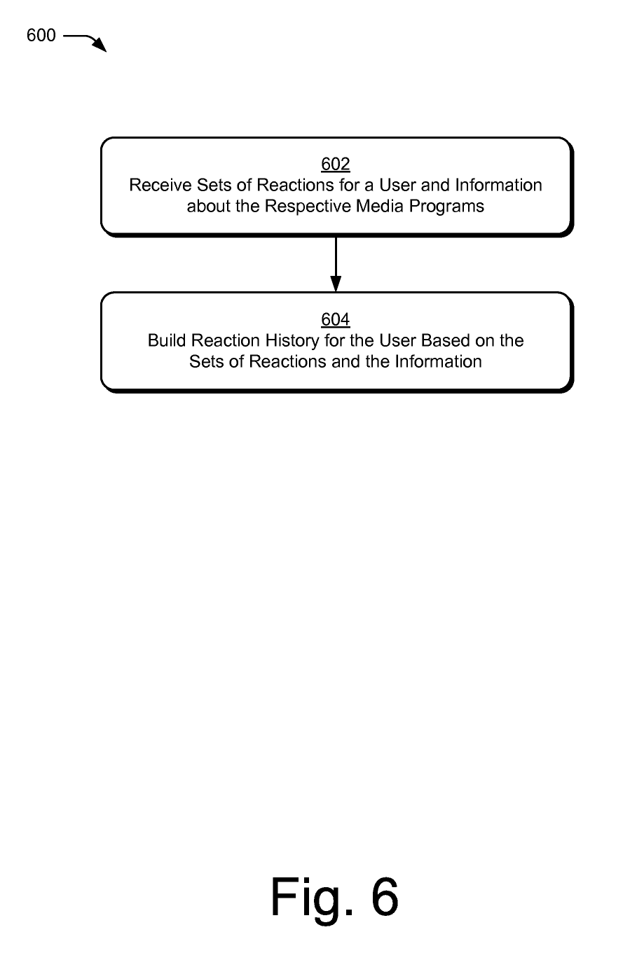

FIG. 6 depicts methods 600 for building a reaction history based on a user's reactions to media programs. Block 602 receives sets of reactions of a user, the sets of reactions sensed during presentation of multiple respective media programs, and information about the respective media programs. An example set of reactions to a media program is illustrated in FIG. 5, those shown being a measure of interest level over the time in which the program was presented to the user.

The information about the respective media programs can include, for example, the name of the media (e.g., The Office, Episode 104) and its type (e.g., a song, a television show, or an advertisement) as well as other information set forth herein.

In addition to the media reactions and their respective media programs, block 602 may receive a context for the user during which the media program was presented as noted above.

Further still, block 602 may receive media reactions from other users with which to build the reaction history. Thus, history module 214 may determine, based on the user's media reactions (either in part or after building an initial or preliminary reaction history for the user) other users having similar reactions to those of the user. History module 214 may determine other persons that have similar reactions to those of the user and use those other persons' reactions to programs that the user has not yet seen or heard to refine a reaction history for the user.

Block 604 builds a reaction history for the user based on sets of reactions for the user and information about the respective media programs. As noted, block 604 may also build the user's reaction history using other persons' reaction histories, contexts, and so forth. This reaction history can be used elsewhere herein to determine programs likely to be enjoyed by the user, advertisements likely to be effective when shown to the user, and for other purposes noted herein.

Methods for Presenting Advertisements Based on a Current Media Reaction

As noted above, the techniques may determine a user's current media reaction, such as an engagement, state, and/or interest level. The following methods address how a current media reaction can be used to determine an advertisement to present.

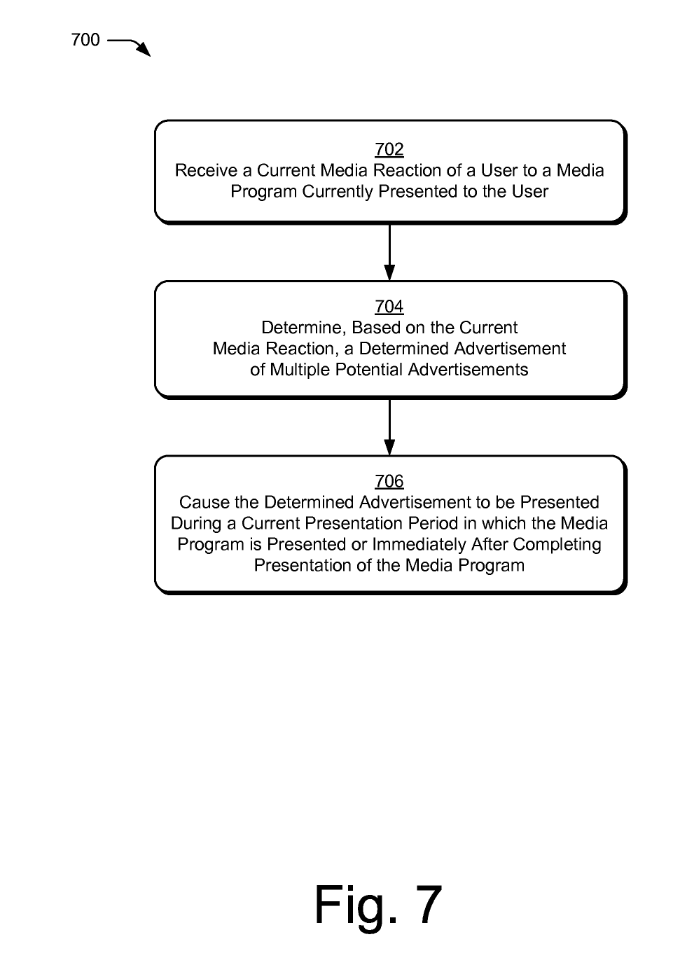

FIG. 7 depicts methods 700 for presenting an advertisement based on a current media reaction, including by determining which advertisement of multiple potential advertisements to present.

Block 702 receives a current media reaction of a user to a media program, the media program currently presented to the user. The current media reaction can be of various kinds and in various media, such as a laugh to a scene of a comedy, a cheer to a sports play of a live sporting game, dancing to a song or music video, being distracted during a drama, intently watching a commercial for a movie, or talking to another person in the room also watching a news program, to name just a few. The media program is one that is currently being presented to a user, such as user 116-1 of FIG. 1, rather than an historic media reaction, though a reaction history or other current media reactions made earlier during the same media program may be used in addition to a newest, current media reaction.

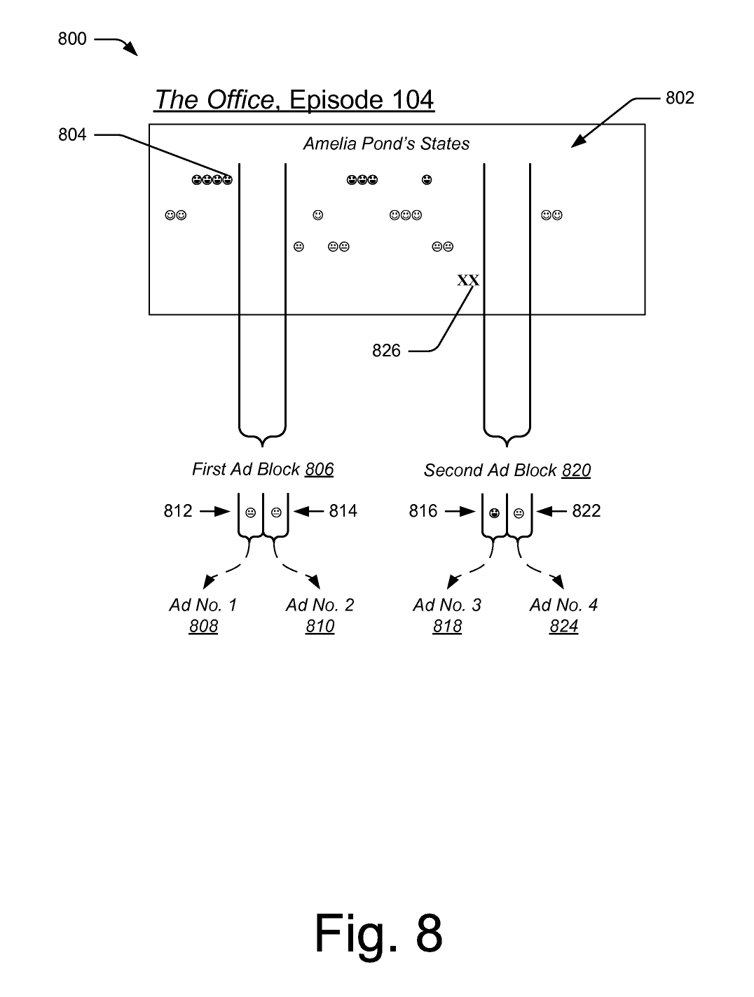

By way of example, consider FIG. 8, which illustrates current media reactions to a comedy program (The Office, Episode 104) over a portion of the program as the program is being presented, shown at time-based state graph 800. Here 23 media reactions 802 are shown, the media reactions being states received by advertisement module 218 from state module 106 and for a user named Amelia Pond. For visual brevity, time-based state graph 800 shows only four states, laughing (shown with “ [symbol] ”), smiling (shown with “ [symbol] ”), interested (shown with “ [symbol] ”), and departed (shown with “X”).

Block 704 determines, based on the current media reaction to the media program, a determined advertisement of multiple potential advertisements. Block 704 may determine which advertisement to show and when based on the current media reaction as well as other information, such as a reaction history for the user (e.g., reaction history 216 of FIG. 2 for Amelia Pond), a context for the current media reaction (e.g., Amelia Pond's location is sunny or she just got home from school), demographics of the user (e.g., Amelia Pond is a 16-year-old female that speaks English and lives in Seattle, Wash., USA), the type of media program (e.g., a comedy), or a media reaction of another user also in the audience (e.g., Amelia Pond's brother Calvin Pond reacted in a certain way). Block 704 may determine which advertisement to show immediately following the current media reaction, such as to a last scene shown in the program before an advertisement is shown, though instead block 704 may also use current media reactions that are not immediately before the advertisement or use multiple current media reactions, such as the last six media reactions, and so forth.

Continuing the ongoing embodiment, assume that the current media reaction is reaction 804 of FIG. 8 in which Amelia Pond is laughing at a current scene of the show The Office. Assume also that at the end of the scene, which ends in 15 seconds, a first ad block 806 begins. This first ad block 806 is one-minute long and is scheduled to include two 30-second advertisements, one for ad no. 1 808 and another for ad no. 2 810.

Assume also for this case that a first advertiser has previously purchased the right to ad no. 1 808 and for this spot has previously provided three different potential advertisements one of which will be played based on the current media reaction. Thus, advertisement module 218 first ascertains that there are three potential advertisements in advertisements 220 both of FIG. 2 or 3, and which is appropriate. Here the advertiser was aware, in advance, that the program was The Office and that it is Episode 104. Assume that this program is being watched for the first time, and thus other media reactions of other users have not been recorded for the whole program. Based on information about the program generally, however, one advertisement is indicated as appropriate to play if the current media reaction is laughing or smiling, one if the reaction departed, and another is for all other states. Assume that the advertiser is a large car manufacturer, and that the first advertisement (for laughing or smiling) is for a fun, quick sports car, that the second, because it will play if the user has departed the room, is repetitive and audio-focused, stating the virtues of the manufacturer (e.g., Desoto cars are fast, Desoto cars are fun, Desoto cars are a good value) in the hopes that the user is within hearing distance of the advertisement, and the third is for a popular and sensible family car.

Note that this is a relatively simple case using a current media reaction and based in part on the type or general information about the program. An advertiser may instead provide 20 advertisements for many current media reactions as well as demographics about a user and a user's reaction history. Thus, advertisement module 218 may determine that five of the 20 advertisements are potentially appropriate based on the user being a male between 34 and 50 years of age and thus excluding various cars sold by the manufacturer that are generally not good sellers for men of this age group. Advertisement module 218 may also determine that two of the five are more appropriate based on the user's reaction history indicating that he has positively reacted to fishing shows and auto-racing shows and therefore showing trucks and sport utility vehicles. Finally, advertisement module 218 may determine which of these two to present based on the user's current media reaction indicating that the user was highly engaged with the program and thus showing an advertisement for trucks that goes into detail about the trucks in the assumption that the user is paying sufficient attention to appreciate those details rather than a less-detailed, more-stylistic advertisement.

Block 706 causes the determined advertisement to be presented during a current presentation period in which the media program is presented or immediately after completing presentation of the media program. Block 706 may cause the determined advertisement to be presented by presenting the advertisement or by indicating to a presentation entity, such as media presentation device 102 of FIG. 2, that the determined advertisement should be presented. The current presentation period is an amount of time sufficient to present the media program but may also include an amount of time sufficient to present a previously determined number of advertisements or amount of time to present advertisements.

Concluding the ongoing embodiment concerning Amelia Pond, consider again FIG. 8. Here advertisement module 218 caused media presentation device 102 of FIG. 2 to present the first advertisement for a fun, quick sports car based on Amelia's current media reaction being a laugh.

Advertisement module 218 may base its determination on media reactions other than a most-recent media reaction, whether these reactions are current to the media program or the current presentation period for the media program or for other programs, such as those on which a user's reaction history is based. Current media reactions may also be those that are received for reactions during the current presentation period but not for the program. Thus, a user's reaction to a prior advertisement shown in advertisement blocks within the current presentation period may also be used to determine which advertisement to present.

Methods 700 may be repeated, and thus ad no. 2 810 may be selected at least in part based on the “interested state” shown at advertisement reaction 812. Thus, methods 700 can be repeated for various advertisements and current reactions during the current presentation period, whether the reactions are to a program or an advertisement.

Other advertisement reactions are also shown, a second advertisement reaction 814, a third advertisement reaction 816 for ad no. 3 818 of second ad block 820, and a fourth advertisement reaction 822 for ad no. 4 824. Note that the third advertisement determined to be presented by advertisement module 218 is based in part on a departed state 826 and that the third advertisement determined to be presented in based on the user laughing at the third advertisement. These are but a few of the many examples in which current media reactions can be used by the techniques to determine an advertisement to present.

Optionally, the techniques can determine pricing for an advertisement based on a current media reaction to a media program. Thus, an advertisement may cost less if the user is currently departed or more if the user is currently laughing or otherwise engaged. The techniques, then, are capable of setting prices for advertisements based on media reactions, including independent of an advertiser's bid to present an advertisement. In such a case the techniques may present advertisements based on which advertiser agrees or has agreed to the price, as opposed to a highest bid structure, or some combination of bids and determined pricing. One example of a combination of bids and determined pricing is an opening price set by the techniques based on media reactions, and then bids from advertisers bidding based on the opening price.

Also optionally, the techniques may enable users to explicitly interact with an advertisement. An advertisement may include an explicit request for a requested media reaction to facilitate an offer, for example. Thus, the detailed truck advertisement may include text or audio asking a user to raise his or her hand for a detailed sales brochure to be sent to the user's email or home address, or an advertisement for a delivery pizza chain of stores may ask a user to cheer for ½ off a home delivery pizza for delivery during a currently-playing football game. If the user raises his or her hand, the techniques pass this state to the associated advertiser, which may then send back a phone number to display within the advertisement for the user's local store along with a code for ½ off the pizza.

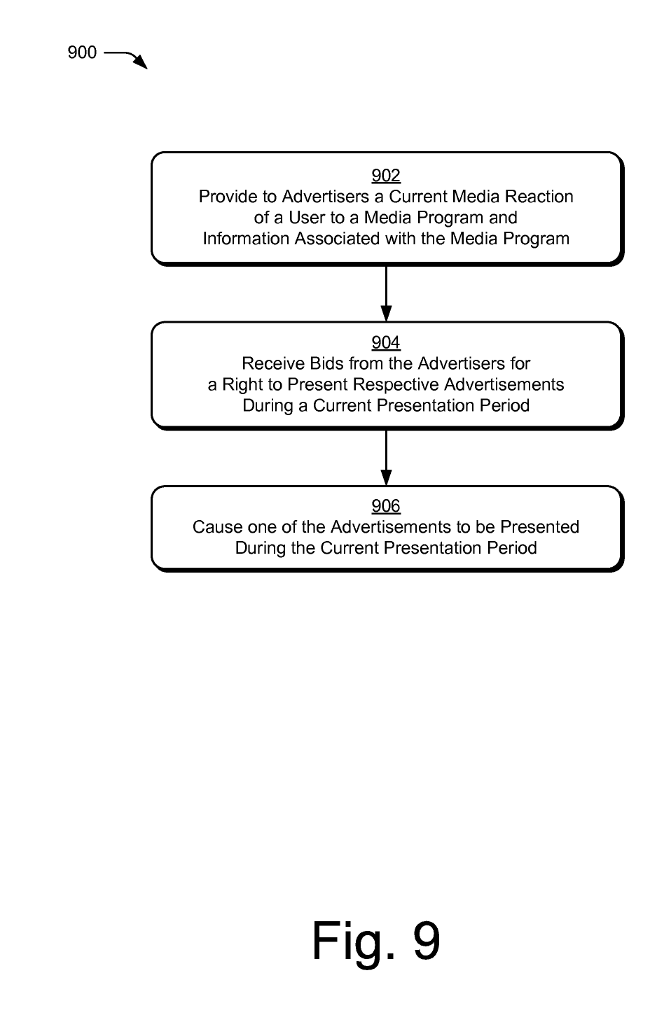

FIG. 9 depicts methods 900 for presenting an advertisement based on a current media reaction, including based on bids from advertisers.

Block 902 provides to advertisers a current media reaction of a user to a media program currently presented to the user. Block 902 may provide the current media reaction as received or determined in various manners described above, such as with state module 106, interest module 108, and/or advertisement module 218. Block 902 may also provide other information, such as a reaction history or portions thereof for the user, demographic information about the user, a context in which the user is presented the media program, or information about the media program.

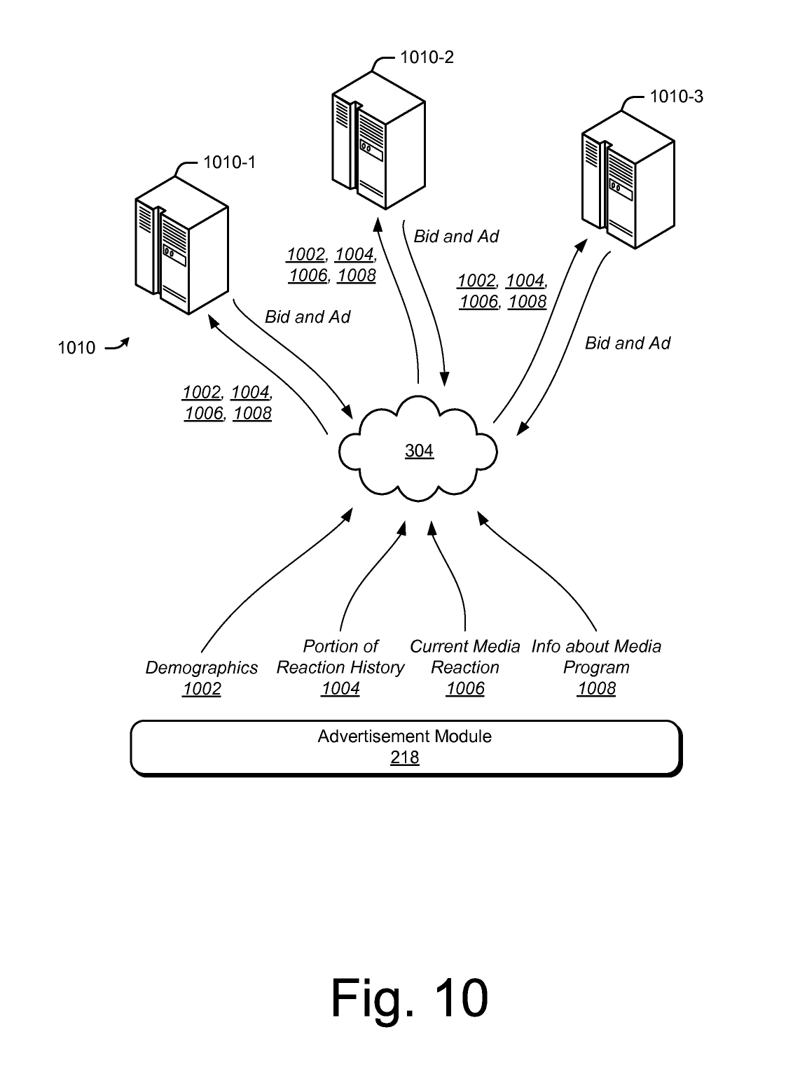

Consider, for example, FIG. 10, which illustrates advertisement module 218 providing, through communication network 304, demographics 1002, a portion of reaction history 1004, a current media reaction 1006, and information about the media program 1008 to advertisers 1010 (shown including first, second, and third advertisers 1010-1, 1010-2, and 1010-3, respectively).

Assume here that demographics 1002 indicate that the user is a 33-year-old female that is married with one child. Assume also that the portion of reaction history 1004 indicates the user's identity, namely Melody Pond, and her preference for science fiction programs, the Olympic Games, and prior positive reactions to advertisements for movie trailers, shoe sales, and triathlons. Here assume that current media reaction 1006 indicates disappointment (a sad state) and that information about media program 1008 indicates that the program is a swim meet in which the last section at which the current media reaction was a sad state showed Michael Phelps placing second in an international swim meet to Australian swimmer Ian Thorp.

Block 904 receives bids from the advertisers, the bids for a right to present a respective advertisement to the user and during a current presentation period in which the media program is presented. This right may be to present an advertisement immediately, such as right after the scene or section for the current media reaction completes and prior to another advertisement being shown. This right may instead by for a later portion of the current presentation period, such as a second advertisement after the scene or an advertisement in a block five minutes later, for example.

Consider the above example where the user has a sad state just prior to an advertisement being shown. Some advertisers will not be as interested in presenting advertisements to a user having this state, and so bid lower for the right to show their advertisement, while others consider their advertisements more effective to persons having a sad state. Further, the advertisers likely take into account, and assign value, based also on the user's demographics, reaction history, and which program they are watching. An advertiser selling life insurance or investment plans is more likely to bid high for a right to show directly after a sad state and for a person that has young children, for example, than an advertiser selling carpet-cleaning products.

For this example assume that all three advertisers 1010 bid on the right to show advertisements and include, with each bid, information sufficient for advertisement module 218 to cause the advertisement to be presented, such as with an indicator for an advertisement of advertisements 220 or a universal resource locator at which to retrieve the advertisement.

Block 906 causes one of the advertisements associated with one of the bids to be presented to the user during the current presentation period in which the media program is presented. Block 906 may select to show the advertisement responsive to determining which bid is highest, though a highest bid is not necessarily required. Concluding the example, advertisement module 218 causes the advertisement associated with the highest bid to be presented to the user.

In addition to the manners set forth above, the techniques may provide a number of additional users present during the presentation of the media program, including in some cases their current media reaction and so forth, thereby likely increasing the size of the bids.

Further, advertisement module 218 may receive a media reaction to the advertisement shown and, based on the reaction, reduce or increase the cost for the advertisement relative to the bid made for that advertisement.

Methods 900 may be repeated, in whole or in part, for later advertisements, including based on current media reactions to prior advertisements, similarly to as described in examples of methods 700.

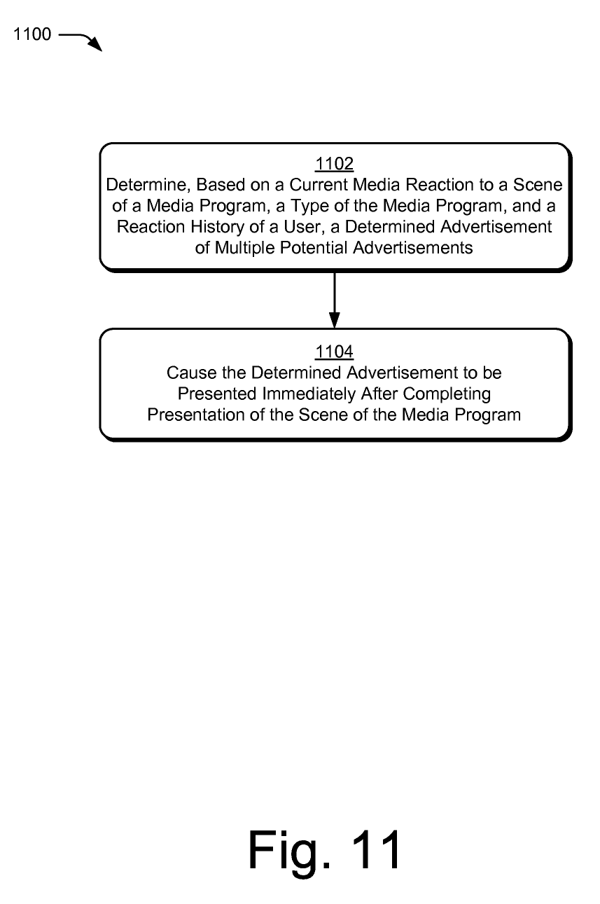

FIG. 11 depicts methods 1100 for presenting an advertisement based on a current media reaction, including immediately following a scene in which the current media reaction was made.

Block 1102 determines, based on a current media reaction to a scene of a media program being presented to a user, a type of the media program, and a reaction history associated with the user, a determined advertisement of multiple potential advertisements. Manners in which this may be performed as set forth above.

Block 1104 causes the determined advertisement to be presented immediately after completing presentation of the scene of the media program.

The preceding discussion describes methods relating to advertisement presentation based on a current media reaction, as well as other methods and techniques. Aspects of these methods may be implemented in hardware (e.g., fixed logic circuitry), firmware, software, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

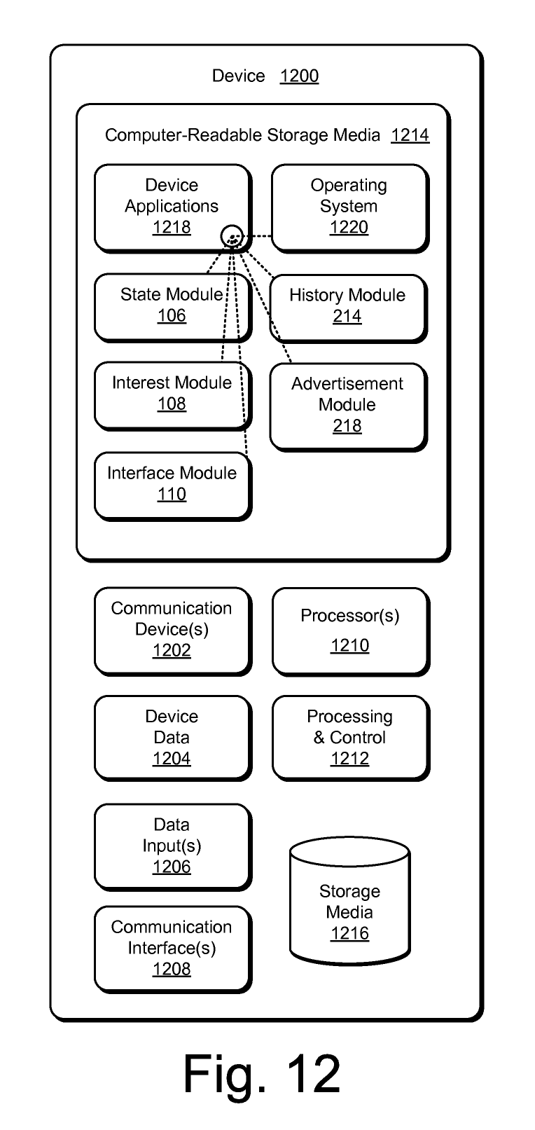

These techniques may be embodied on one or more of the entities shown in FIGS. 1-3 and 12 (device 1200 is described below), which may be further divided, combined, and so on. Thus, these figures illustrate some of many possible systems or apparatuses capable of employing the described techniques. The entities of these figures generally represent software, firmware, hardware, whole devices or networks, or a combination thereof. In the case of a software implementation, for instance, the entities (e.g., state module 106, interest module 108, interface module 110, history module 214, and advertisement module 218) represent program code that performs specified tasks when executed on a processor (e.g., processor(s) 204 and/or 306). The program code can be stored in one or more computer-readable memory devices, such as CRM 206 and/or remote CRM 308 or computer-readable storage media 1214 of FIG. 12.

Example Device

FIG. 12 illustrates various components of example device 1200 that can be implemented as any type of client, server, and/or computing device as described with reference to the previous FIGS. 1-11 to implement techniques enabling advertisement presentation based on a current media reaction. In embodiments, device 1200 can be implemented as one or a combination of a wired and/or wireless device, as a form of television mobile computing device (e.g., television set-top box, digital video recorder (DVR), etc.), consumer device, computer device, server device, portable computer device, user device, communication device, video processing and/or rendering device, appliance device, gaming device, electronic device, System-on-Chip (SoC), and/or as another type of device or portion thereof. Device 1200 may also be associated with a user (e.g., a person) and/or an entity that operates the device such that a device describes logical devices that include users, software, firmware, and/or a combination of devices.

Device 1200 includes communication devices 1202 that enable wired and/or wireless communication of device data 1204 (e.g., received data, data that is being received, data scheduled for broadcast, data packets of the data, etc.). Device data 1204 or other device content can include configuration settings of the device, media content stored on the device (e.g., media programs 210), and/or information associated with a user of the device. Media content stored on device 1200 can include any type of audio, video, and/or image data. Device 1200 includes one or more data inputs 1206 via which any type of data, media content, and/or inputs can be received, such as human utterances, user-selectable inputs, messages, music, television media content, media reactions, recorded video content, and any other type of audio, video, and/or image data received from any content and/or data source.

Device 1200 also includes communication interfaces 1208, which can be implemented as any one or more of a serial and/or parallel interface, a wireless interface, any type of network interface, a modem, and as any other type of communication interface. Communication interfaces 1208 provide a connection and/or communication links between device 1200 and a communication network by which other electronic, computing, and communication devices communicate data with device 1200.

Device 1200 includes one or more processors 1210 (e.g., any of microprocessors, controllers, and the like), which process various computer-executable instructions to control the operation of device 1200 and to enable techniques for advertisement presentation based on a current media reaction and other methods described herein. Alternatively or in addition, device 1200 can be implemented with any one or combination of hardware, firmware, or fixed logic circuitry that is implemented in connection with processing and control circuits which are generally identified at 1212. Although not shown, device 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1200 also includes computer-readable storage media 1214, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1200 can also include a mass storage media device 1216.

Computer-readable storage media 1214 provides data storage mechanisms to store device data 1204, as well as various device applications 1218 and any other types of information and/or data related to operational aspects of device 1200. For example, an operating system 1220 can be maintained as a computer application with computer-readable storage media 1214 and executed on processors 1210. Device applications 1218 may include a device manager, such as any form of a control application, software application, signal-processing and control module, code that is native to a particular device, a hardware abstraction layer for a particular device, and so on.

Device applications 1218 also include any system components, engines, or modules to implement techniques enabling advertisement presentation based on a current media reaction. In this example, device applications 1218 can include state module 106, interest module 108, interface module 110, history module 214, and/or advertisement module 218.

### CONCLUSION

Although embodiments of techniques and apparatuses enabling advertisement presentation based on a current media reaction have been described in language specific to features and/or methods, it is to be understood that the subject of the appended claims is not necessarily limited to the specific features or methods described. Rather, the specific features and methods are disclosed as example implementations enabling advertisement presentation based on a current media reaction.

1. A computer-implemented method comprising:
receiving a current media reaction of a user to a media program;
determining, based on the current media reaction to the media program, a determined advertisement of multiple potential advertisements; and
causing the determined advertisement to be presented during a current presentation period in which the media program is being presented to the user or immediately after completing presentation of the media program.

2. A computer-implemented method as described in claim 1, wherein the current media reaction is to a scene of the media program and causing the determined advertisement to be presented causes the determined advertisement to be presented immediately following the scene.

3. A computer-implemented method as described in claim 1, further comprising receiving other current media reactions, the current media reaction being a most-recent media reaction and the other media reactions being prior to the current media reaction but during the current presentation period, and wherein determining the advertisement is based on both the current media reaction and the other media reactions.

4. A computer-implemented method as described in claim 3, wherein one or more of the other media reactions is to a previously presented advertisement presented during the current presentation period.

5. A computer-implemented method as described in claim 1, wherein determining the determined advertisement is further based on:
a reaction history of the user, the reaction history including sets of reactions to other media programs;
a context of the user during the current media reaction;
demographics of the user; or
a type of the media program.

6. A computer-implemented method as described in claim 1, further comprising receiving a second media reaction of a second user in physical proximity to the first-mentioned user and wherein determining the determined advertisement is further based on the second media reaction of the second user to the media program.

7. A computer-implemented method as described in claim 1, wherein the media program is a television show, a movie, a music video, a video clip, an advertisement, an e-book, a computer game, or a song.

8. A computer-implemented method as described in claim 1, wherein the media reaction is a state determined based on passive sensor data sensed during the current presentation period.

9. A computer-implemented method as described in claim 1, wherein the current presentation period is:
a first amount of time sufficient to present the media program; and
a second amount of time sufficient to present a previously determined number of advertisements; or
a third amount of time previously determined in which to present one or more advertisements.

10. A computer-implemented method as described in claim 1, further comprising determining a price to present the determined advertisement based on the current media reaction.

11. A computer-implemented method as described in claim 1, wherein the determined advertisement includes an explicit request for a requested media reaction to facilitate an offer and further comprising causing an indication to be presented indicating the offer responsive to performance of the requested media reaction.

12. (canceled)

13. (canceled)

14. (canceled)

15. (canceled)

16. (canceled)

17. (canceled)

18. (canceled)

19. (canceled)

20. A computer-implemented method comprising:
determining, based on a current media reaction to a scene of a media program being presented to a user, a type of the media program, and a reaction history associated with the user, a determined advertisement of multiple potential advertisements; and
causing the determined advertisement to be presented immediately after completing presentation of the scene of the media program.

21. A computing system comprising:
one or more processors; and
one or more computer-readable media storing instructions that are executable via the one or more processors to cause the computing system to perform operations including:
receiving a current media reaction of a user to a media program, the current media reaction determined by one or more physical acts of the user;
determining, based on the current media reaction to the media program, a determined advertisement out of multiple potential advertisements; and
causing the determined advertisement to be presented during a presentation period of the media program being presented or immediately following the presentation period of the media program being presented.

22. A computing system as recited in claim 21, wherein the instructions are executable to cause the computing system to perform operations including establishing the current media reaction to a scene and presenting the determined advertisement immediately following the scene.

23. A computing system as recited in claim 21, wherein the instructions are executable to cause the computing system to perform operations including receiving other current media reactions prior to the current media reactions but during the presentation period, and wherein determining the advertisement is based on both the current media reaction and the other current media reactions.

24. A computing system as recited in claim 23, wherein the instructions are executable to cause the computing system to perform operations including receiving other media reactions to a previously presented advertisement.

25. A computing system as recited in claim 21, wherein determining the determined advertisement is further based on one or more of:
a reaction history of the user, the reaction history including sets of reactions to other media programs;
a context of the user during the current media reaction;
demographics of the user; or
a type of the media program.

26. A computing system as recited in claim 21, wherein the instructions are executable to cause the computing system to perform operations including receiving other media reactions of other users in physical proximity to the first-mentioned user and wherein determining the determined advertisement is further based on the other media reactions of the other users to the media program.

27. A computing system as recited in claim 21, wherein determining the media reaction is further based on sensor data passively received during the current presentation period.

28. A computing system as recited in claim 21, wherein the instructions are executable to cause the computing system to perform operation including determining a price to present the determined advertisement based on the current media reaction.
